(19) United States
(12) Patent Application Publication
(10) Pub. No.: US 2008/0106502 A1
(43) Pub. Date: May 8, 2008

(54) LIGHT-EMITTING DEVICE

(75) Inventor: Tatsuya HONDA, Isehara (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 11/933,014

(22) Filed: Oct. 31, 2007

(30) Foreign Application Priority Data
Nov. 3, 2006 (JP) 2006-299712

(51) Int. Cl. G09G 3/30

(52) U.S. Cl. 345/76

(57) ABSTRACT

One aspect of the present invention is the light-emitting device including a switching transistor, a first driving transistor which is a p-channel transistor, a second driving transistor which is an n-channel transistor, an inorganic EL element, and a resistor; one of a source region and a drain region of the switching transistor is electrically connected to gate electrodes of the first driving transistor and the second driving transistor; one of a source region and a drain region of the first driving transistor and one of a source region and a drain region of the second driving transistor are electrically connected to the resistor; and a driving voltage is divided to the resistor by providing the resistor between both the first driving transistor and the second driving transistor and the inorganic EL element.

### BACKGROUND OF THE PRESENT INVENTION

1. Field of the Present Invention

The present invention relates to light-emitting elements utilizing electroluminescence. Further, the present invention relates to light-emitting devices and electronic appliances having such light-emitting elements.

2. Description of the Related Art

In recent years, research and development of light-emitting elements utilizing electroluminescence (EL) (hereinafter also referred to as “EL elements”) have been actively conducted. The basic configuration of a light-emitting element is such that a light-emissive substance is interposed between a pair of electrodes, and light emission from the light-emissive substance is obtained upon application of a voltage between the pair of electrodes.

Being of a self-luminous type, such a light-emitting element has advantages over liquid crystal displays in that it has wide viewing angles, high visibility, and high response speed as well as the feasibility of reduction in thickness and weight.

Light-emitting elements can be divided into organic EL elements which use an organic compound as a light-emissive substance which exhibits electroluminescence and inorganic EL elements which use an inorganic compound as a light-emissive substance which exhibits electroluminescence.

These organic and inorganic EL elements differ not only in their light-emitting materials but also in their light-emission mechanisms.

The inorganic EL elements, which are electric field excitation light-emitting elements, are classified into a dispersion-type and a thin-film type in accordance with their element structures. The difference between the two EL elements is in that the former dispersion-type inorganic EL element includes a light-emitting layer in which a particulate light-emitting material is dispersed in a binder, while the latter thin-film-type light-emitting element has a light-emitting layer formed using a thin film of a light-emitting material between dielectric layers. Although the two light-emitting elements are different in the above points, they have a common characteristic in that both require electrons that are accelerated by a high electric field (for example, see Patent Document 1: Japanese Published Patent Application No. 2001-250691). As types of light-emission mechanisms, there are donor-acceptor recombination emission which utilizes a donor level and an acceptor level, and localized light emission which utilizes inner-shell electron transition of metal ions.

### SUMMARY OF THE PRESENT INVENTION

Inorganic EL elements are excellent in reliability compared to organic EL elements because an inorganic material is used for a light emitting layer to control luminance decay with time.

However, at present, inorganic EL elements require higher driving voltage than organic EL elements; therefore, it is difficult to ensure the reliability of a transistor such as a thin film transistor (TFT) which drives an EL element. Therefore, in the case of using the inorganic EL elements, it is still difficult to manufacture active matrix light-emitting devices while it is possible to manufacture passive matrix light-emitting devices having difficulty in improvement in definition. That is, electric field excitation light-emitting elements using an inorganic light-emitting material are excellent in reliability; on the other hand, there is such a problem that the electric field excitation light-emitting elements using an inorganic light-emitting material require a high driving voltage.

Thus, it is an object of the present invention to manufacture a light-emitting device with the utilization of advantages of an electric field excitation light-emitting element in order to obtain a light-emitting device with high definition and high reliability.

One aspect of the present invention is a light-emitting device including a pixel formed of an electric field excitation light-emitting element which is electrically connected to a transistor. The pixel is provided with a resistor which divides a voltage applied to the transistor at the time of non-light-emission of the electric field excitation light-emitting element.

The light-emitting device of the present invention includes driving transistors to be connected to an electric field excitation light-emitting element, a switching transistor to control operation of the driving transistors, a resistance factor to suppress a voltage applied to the driving transistors in maintaining non-light-emission of the electric field excitation light-emitting element.

It is to be noted that the electric field excitation light-emitting element includes a light-emitting element having a light-emitting layer in which a particulate light-emitting material is dispersed in a binder or a light-emitting element having a light-emitting layer formed of a thin film containing a light-emitting material between dielectric layers.

In accordance with the present invention, a driving voltage applied to driving transistors can be lowered to reduce load on the driving transistors. Thus, a light-emitting device or a semiconductor device with high definition and high reliability can be obtained.

### BRIEF DESCRIPTION OF THE DRAWINGS

In the accompanying drawings:

FIG. 1 is a cross-sectional view of an inorganic EL element in accordance with Embodiment Mode 1.

FIG. 2 is a circuit diagram explaining a pixel configuration in accordance with Embodiment Mode 1.

FIG. 3 is a circuit diagram explaining a main part of the circuit illustrated in FIG. 2.

FIG. 4 is a plan view illustrating a pixel configuration in accordance with Embodiment Mode 2.

FIG. 5 is a plan view illustrating a configuration of a pixel portion including a plurality of pixels that are the same as the pixel illustrated in FIG. 4.

FIG. 6 is a cross-sectional view illustrating a structure of a cross section taken along line A-A′ in FIG. 4.

FIGS. 7A to 7D are cross-sectional views illustrating a method for manufacturing a light-emitting device in accordance with Embodiment Mode 2.

FIGS. 8A to 8D are cross-sectional views illustrating a method for manufacturing a light-emitting device in accordance with Embodiment Mode 2.

FIG. 9 is a cross-sectional view illustrating a method for manufacturing a light-emitting device in accordance with Embodiment Mode 2.

FIGS. 10A to 10D illustrate examples of electronic appliances in which a display apparatus is incorporated.

FIG. 11 illustrates an example of an electronic appliance in which display device are incorporated.

### DETAILED DESCRIPTION OF THE PRESENT INVENTION

Embodiment modes and Embodiment of the present invention will be described below with reference to the accompanying drawings. Note that the present invention is not limited to the following description, and it will be easily understood by those skilled in the art that various changes and modifications can be made without departing from the spirit and scope of the present invention. Therefore, the present invention should not be construed as being limited to the description in the following embodiment modes and embodiment. Note that the portions that are common or portions having similar functions in different drawings are shown by the same reference numerals, and their repetitive description will be omitted.

### Embodiment Mode 1

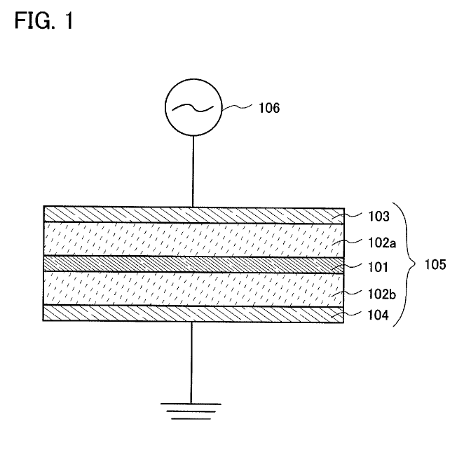

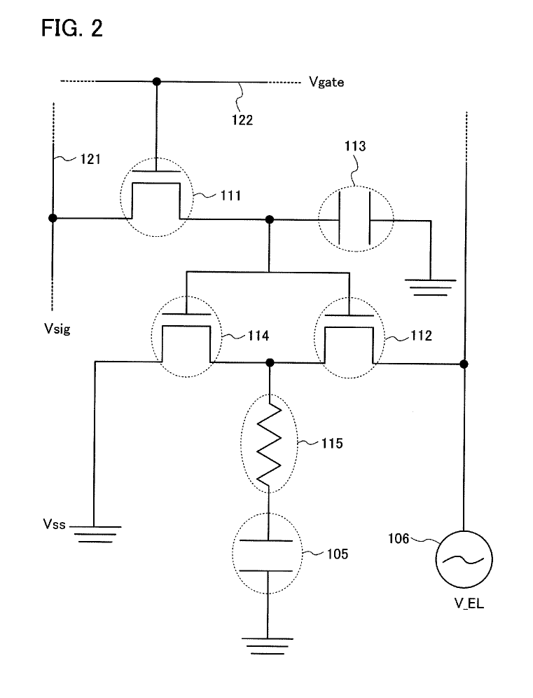

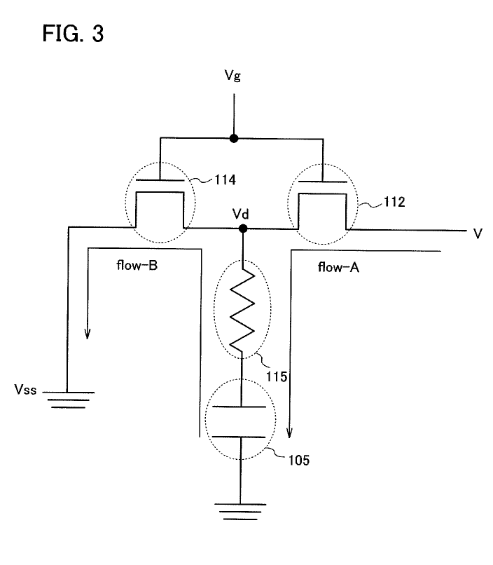

In this embodiment mode, using FIG. 1, FIG. 2, and FIG. 3, a structure of an electric field excitation light-emitting element and a driving method thereof will be described. It is to be noted that, hereinafter, a case of using an inorganic EL element will be described as a typical example of the electric field excitation light-emitting element.

FIG. 1 illustrates an example of a structure of an inorganic EL element of this embodiment mode. An inorganic EL element 105 of FIG. 1 includes a first electrode 103, a first insulating film 102a, a light-emitting layer 101 containing an inorganic material, a second insulating film 102b, and a second electrode 104. The first electrode 103 is electrically connected to a power supply 106 to apply an AC voltage. The second electrode 104 is electrically connected to a ground potential.

The light-emitting layer 101 contains the inorganic material such as sulfide which is a base material of the light-emitting layer 101 and an impurity element to be an emission center. Zinc sulfide, calcium sulfide, zinc oxide, or the like is used as the inorganic material to be the base material. Manganese (Mn) or the like is used as the impurity element to be the emission center.

For the insulating film 102a and the insulating film 102b, silicon oxide, silicon nitride, aluminum oxide, barium titanate, or the like is used.

A single layer film formed using indium tin oxide (ITO), aluminum (Al), silver (Ag), molybdenum (Mo), or the like or a multilayer film formed using a combination thereof can be used as the electrode 103 and the electrode 104.

The inorganic EL element 105 illustrated in FIG. 1 has a configuration in which the light-emitting layer 101 is interposed between the insulating film 102a and the insulating film 102b and these films are sandwiched by the electrode 103 and the electrode 104 on either outer side.

For driving of the inorganic EL element 105, electrons are accelerated by application of, for example, an AC voltage of 100 to 250 V to the electrodes 103 and 104, and collided with impurity atoms in the light-emitting layer 101 to make the electrons excited. Then, when the excited electrons relax to a ground state, energy is released as light; that is, light is emitted.

An emission wavelength varies depending on an impurity element added to the base material; accordingly, the light-emitting layer 101 can be formed with a different impurity element per a pixel. Alternatively, it is possible to provide color filters in order to make each pixel emit a different color without changing the impurity element. In this manner, a light-emitting device for color display can be obtained.

For example, emission colors of the pixels are changed by changing the impurity elements as follows: for example, Mn is added to zinc sulfide to obtain yellow-orange emission, silver chloride (AgCl) is added to zinc sulfideto obtain blue emission, or copper (Cu) and aluminum (Al) are added to zinc sulfide to obtain green emission.

One of the reasons why the inorganic EL element 105 requires a high driving voltage is that the number of carriers to excite the atoms of impurity element is not enough. The carriers refer to electrons in each of the insulating film 102a and the insulating film 102b or the electrons that are trapped at the interface level between the insulating film 102a and the light-emitting layer 101 and at the interface level between the insulating film 102b and the light-emitting layer 101.

FIG. 2 illustrates such a circuit configuration that driving transistors are not loaded even if the driving voltage of the inorganic EL element 105 is high. The circuit of FIG. 2 includes a switching transistor 111, a first driving transistor 112, a second driving transistor 114, the inorganic EL element 105, a power supply 106, a storage capacitor 113, a resistor 115, a source line 121, and a gate line 122. It is to be noted that the same portions as FIG. 1 are denoted by the same reference numerals.

The switching transistor 111 needs to immediately transmit an electric potential of the source line 121 to gate electrodes of the first driving transistor 112 and the second driving transistor 114 without any loss. Therefore, the switching transistor 111 is desirably operated in the linear region in which the channel resistance is low.

Although an n-channel transistor or a p-channel transistor can be used as the switching transistor 111, an n-channel transistor whose channel resistance is low is preferable.

When the gate potential and the threshold voltage of the switching transistor 111 are denoted by V_{gate} and V_{thsw}, respectively, and the electric potential of the source line 121 is denoted by V_{sig}, the condition for linear operation of the switching transistor 111 is V_{gate}−V_{thsw}>V_{sig}. V_{gate} and V_{sig} may be set so as to satisfy this condition.

For the switching transistor 111, it is desirable that off-state current (off-current) be as low as possible as with the first driving transistor 112 and the second driving transistor 114. Therefore, the switching transistor 111 desirably has, as a transistor structure, a lightly doped drain (LDD) structure in which a low concentration impurity region is provided in a drain region and a source region, or a multigate structure such as the double gate structure in which a plurality of transistors are connected in series or a triple gate structure.

One of the first driving transistor 112 and the second driving transistor 114 is a p-channel transistor, and the other is an n-channel transistor.

In the configuration of FIG. 2, the switching transistor 111, the first driving transistor 112 which is a p-channel transistor, the second driving transistor 114 which is an n-channel transistor, the inorganic EL element 105, and the resistor 115 are formed. One of a source region and a drain region of the switching transistor 111 is electrically connected to the gate electrodes of the first driving transistor 112 and the second driving transistor 114. One of a source region and a drain region of the first driving transistor 112 and one of a source region and a drain region of the second driving transistor 114 are electrically connected to the resistor 115. The resistor 115 and the inorganic EL element 105 are electrically connected to each other. A driving voltage can be divided to the resistor 115 by providing the resistor 115 between both the first driving transistor 112 and the second driving transistor 114 and the inorganic EL element 105.

Specifically, the switching transistor 111 controls gates of the first driving transistor 112 and the second driving transistor 114. The first driving transistor 112 and the second driving transistor 114 controls a voltage applied to the inorganic EL element 105. A DC voltage V_{gate} is applied to the gate line 122 in order to turn on or off the switching transistor 111. A DC voltage V_{sig} is applied to the source line 121 in order to turn on or off the first driving transistor 112 and the second driving transistor 114. It is to be noted that gray scale can be displayed by changing the size of the amplitude of the voltage V_{sig}.

The storage capacitor 113 retains gate potentials of the first driving transistor 112 and the second driving transistor 114. The power supply 106 applies a voltage V_EL to the inorganic EL element 105. In this embodiment mode, because the inorganic EL element 105 has a capacitive property, the voltage V_EL is an AC voltage.

As illustrated in FIG. 2, even if the driving voltage V_EL is high, it can be divided to the resistor 115 by providing the resistor 115 between both the first driving transistor 112 and the second driving transistor 114 and the inorganic EL element 105. Thus, load on the first driving transistor 112 and the second driving transistor 114 can be reduced; the first driving transistor 112 and the second driving transistor 114, and further the whole light-emitting device including the first driving transistor 112 and the second driving transistor 114 can be improved in reliability.

Transistor deterioration is caused as follows: hot carriers having high energy accelerated by a drain electric field is collided with the interface between a gate insulating film and an active layer to divide atomic bonds at the interface and generate dangling bonds (uncombined hands) and the like. Instead, the transistor deterioration is caused even when hot carriers enter a gate insulating film to become fixed electric charges or to generate defects.

The resistor 115 is desirably set so that the first driving transistor 112 and the second driving transistor 114 each operate in the linear region. The reason will be explained below.

In order to suppress the transistor deterioration caused by the hot carriers, the reduction of the drain electric field is the most efficient.

When a transistor operates in the saturation region, most of the drain voltage is applied to a depletion layer having a several hundred nm width generated at the drain end, and thus the drain voltage in the depletion layer is high.

On the other hand, the depletion layer is not generated in the linear region, and because the drain voltage is applied to the whole channel, the drain electric field is small compared with the saturation region. Thus, carriers are not greatly accelerated in the linear region, so that the hot carriers are hard to be generated.

Moreover, the drain electric field of the linear region is inversely proportional to a channel length; therefore, the drain electric field can be reduced by extension of the channel length.

Next, setting a resistance value of the resistor 115 for when the first driving transistor 112 and the second driving transistor 114 each operate in the linear region will be explained below.

FIG. 3 is a view of a peripheral circuit of the first driving transistor 112 among the circuits in FIG. 2. In FIG. 3, the first driving transistor 112 is a p-channel transistor and the second driving transistor 114 is an n-channel transistor. A channel resistance of the first driving transistor 112 is denoted by r_{pc} and a channel resistance of the second driving transistor 114 is denoted by r_{nc}. An intermediate potential between the first driving transistor 112 which is a p-channel transistor and the second driving transistor 114 which is an n-channel transistor is denoted V_{d}. A gate potential applied to the first driving transistor 112 and the second driving transistor 114 is denoted by V_{g} (this is equal to a data line potential V_{sig}). The resistance value of the resistor 115 is denoted by R. A power supply voltage applied from the power supply 106 is denoted by V. A capacitance of the inorganic EL element 105 is denoted by C and the amount of electric charges stored in the inorganic EL element 105 is denoted by Q.

When the gate potential V_{g} is higher than a threshold voltage Vₜₕₙ of the second driving transistor 114 which is an n-channel transistor, that is, the gate potential V_{g}=High, the second driving transistor 114 which is an n-channel transistor is turned on and the first driving transistor 112 which is a p-channel transistor is turned off. Therefore, although the power supply voltage V is applied to the first driving transistor 112, current does not flow to the first driving transistor 112. On the other hand, the second driving transistor 114 is turned on; accordingly current flows thereto and the intermediate potential V_{d} equals to a low power supply potential Vₛₛ (this is the ground potential in this embodiment mode). At this time, the voltage applied to the inorganic EL element 105 is 0 V; consequently, the inorganic EL element 105 does not emit light.

When the gate potential V_{g} is lower than a threshold voltage Vₜₕₚ of the first driving transistor 112 which is a p-channel transistor, that is, V_{g}=Low, the first driving transistor 112 which is a p-channel transistor is turned on and the second driving transistor 114 which is an n-channel transistor is turned off. Consequently, the intermediate potential V_{d} equals to the power supply voltage V. At this time, a potential difference is generated between electrodes at both ends of the inorganic EL element 105; therefore, electric charges are stored in the inorganic EL element 105 through the resistor 115 as shown by flow A in FIG. 3. The power supply voltage V can be divided to the first driving transistor 112 and the resistor 115; therefore, load on the first driving transistor 112 can be reduced. When storing the electric charges in the inorganic EL element 105 is finished, the same amount of the potential difference as the power supply voltage V is generated between the electrodes at both ends of the inorganic EL element 105, and light is emitted.

In a case of the gate potential V_{g}=High in an emission state, the second driving transistor 114 which is an n-channel transistor is turned on and the first driving transistor 112 which is a p-channel transistor is turned off. Then the intermediate potential V_{d} equals to the low power supply potential Vₛₛ. Then, as shown by flow B in FIG. 3, the electric charges are released from the inorganic EL element 105 through the resistor 115 until the potential difference between the electrodes at both ends of the inorganic EL element 105 is 0. At this time, light is not emitted. Because the electric charges stored in the inorganic EL element 105 are released through the resistor 115 and the second driving transistor 114, the voltage applied between the electrodes at both ends of the inorganic EL element 105 at the time of light emission is divided to the second driving transistor 114 and the resistor 115 to reduce load on the second driving transistor 114.

As described above, switching of the gate potential V_{g} between High and Low enables control of light emission of the inorganic EL element 105. Moreover, current does not flow in the circuit illustrated in FIG. 3 after storing electric charges in the inorganic EL element 105 or releasing electric charges from the inorganic EL element 105 is completed; hence a light-emitting device with low power consumption can be obtained.

Next, the resistance value R of the resistor 115 for when the first driving transistor 112 and the second driving transistor 114 each operate in the linear region where deterioration is small is found.

When electric charges flow as shown by flow A in FIG. 3, the first driving transistor 112 which is a p-channel transistor operates in the linear region regardless of the resistance value R of the resistor 115; therefore, the resistance value R of the resistor 115 is found for the case in which electric charges flow as shown by flow B.

When electric charges flow as shown by flow B, the following formula is satisfied.

I·r_{nc}+I·R+Q/C=0 (formula 1)

A differential equation such as formula 2 is obtained by transforming formula 1.

(r_{nc}+R)·dQ/dt=−Q·C (formula 2)

Formula 3 is obtained as the calculation result of formula 2.

Q=C·V·exp (−t/τ), τ=C·(r_{nc}+R) (formula 3)

The dimension of a transient current I is found by differentiation of formula 3 with respect to time t.

I={V/(r_{nc}+R)}·exp (−t/τ) (formula 4)

Here, when V_{ds} is a potential difference between the drain and the source of the second driving transistor 114 which is an n-channel transistor, V_{gs} is a potential difference between the gate and the source thereof, the following relationships are satisfied.

V_{gs}=V_{g}−Vₛₛ=V_{g} (formula 5)

V_{ds}=V_{d}−Vₛₛ=I·r_{nc} (formula 6)

When Vₜₕₙ is a threshold voltage, the condition for operation of the second driving transistor 114 which is an n-channel transistor in the linear region is given as formula 7.

V_{gs}−Vₜₕ>V_{ds} (formula 7)

Formulae 4, 5, and 6 are assigned to formula 7 to obtain formula 8.

V_{gs}−Vₜₕ>{(V·r_{nc})/(r_{nc}+R)}·exp (−t/τ) (formula 8)

Because the right member of formula 8 is the maximum with t=0, the condition of the resistance value R of the resistor 115 may be found with t=0, where t=0 is assigned to formula 8 and it is rearranged to obtain formula 9.

R>[{V−(V_{g}−Vₜₕₙ)}/(V_{g}−Vₜₕ)]·r_{nc} (formula 9)

As is well known, with the use of a gradual channel approximation, the channel resistance of the TFT which is the second driving transistor 114 in the linear region is given as the following formula.

r_{nc}=1/{β·V_{g}−Vₜₕₙ)}, β=(W/L)·(Cₒₓ·μ) (formula 10)

It is to be noted that W and L are the channel width and length, respectively, of the TFT which is the second driving transistor 114. Cₒₓ is a capacitance per a unit area of a gate insulating film and μ is the mobility of the TFT which is the second driving transistor 114. Formula 10 is assigned to formula 9; accordingly, the condition for the resistance value R of the resistor 115 for linear operation of the TFT which is the second driving transistor 114 is obtained as the following formula.

R>{(V−(V_{g}−Vₜₕₙ)}/{β·(V_{g}−Vₜₕₙ)²} (formula 11)

The resistance value R of the resistor 115 can be found as described above; therefore, load on the first driving transistor 112 and the second driving transistor 114 can be reduced. Thus, a light-emitting device with high definition and high reliability can be obtained.

### Embodiment Mode 2

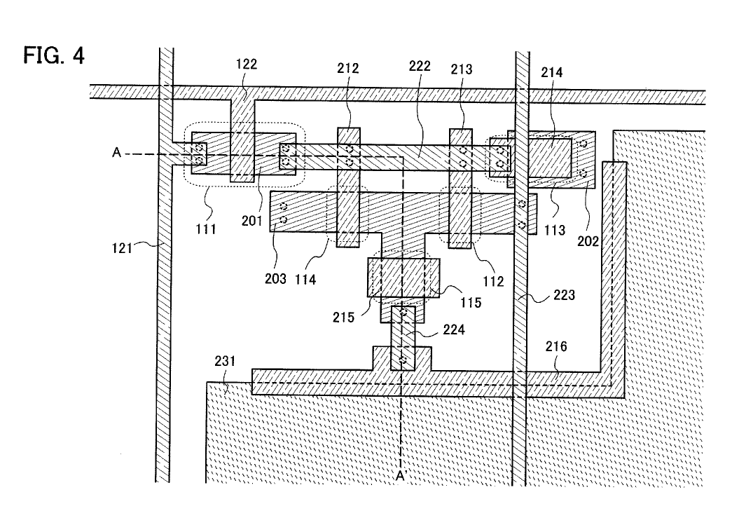

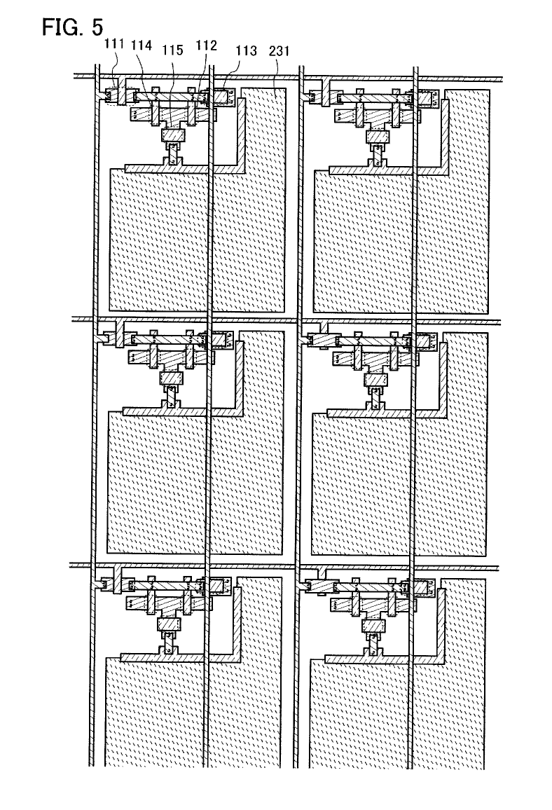

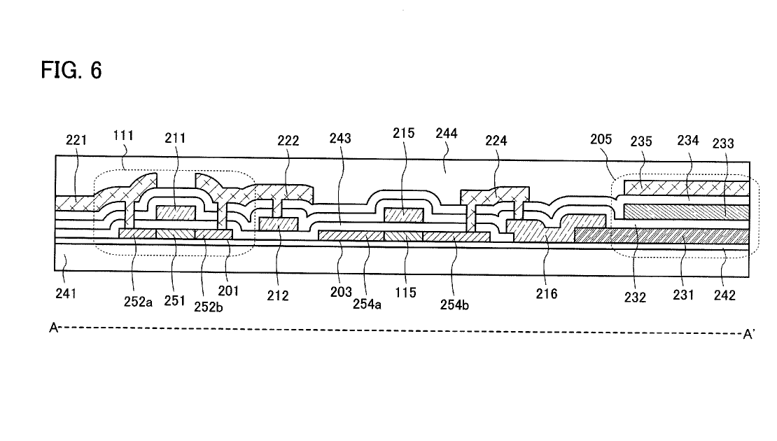

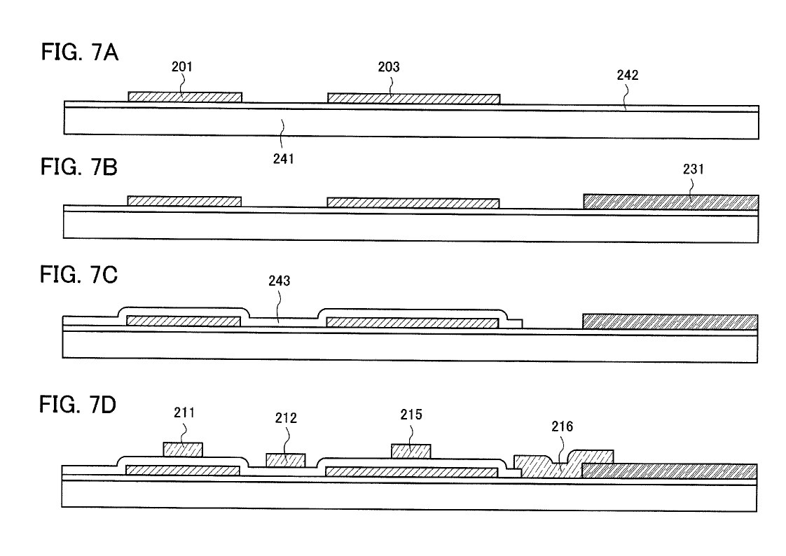

In this embodiment mode, a light-emitting device and a method for manufacturing the same will be described using FIG. 4, FIG. 5, FIG. 6, FIGS. 7A to 7C, FIGS. 8A to 8D, and FIG. 9.

FIG. 4 illustrates part of a pixel provided in the light-emitting device of this embodiment mode. In this embodiment mode, a top gate thin film transistor (TFT) is used as each of the switching transistor 111, the first driving transistor 112, and the second driving transistor 114. In addition, as a light-emitting device of this embodiment mode, an example of a bottom emission-type light-emitting device is illustrated. Moreover, FIG. 6 is a cross-sectional view taken along line A-A of FIG. 4. It is to be noted that the portions that are common with Embodiment Mode 1 are denoted by the same reference numerals.

In the pixel illustrated in FIG. 4, the switching transistor 111, the first driving transistor 112, the second driving transistor 114, the resistor 115, the source line 121, the gate line 122, an island-like semiconductor film 201, an island-like semiconductor film 202, and an island-like semiconductor film 203 are included. In addition, a gate electrode 212, a gate electrode 213, an electrode 214, an electrode 215, and an electrode 216 which are formed using the same material through the same process as the gate line 122 are included. An electrode 222, an electrode 224, and a power supply line 223 which are formed using the same material through the same process as the source line 121 are further included.

A plurality of pixels that are the same as the pixel illustrated in FIG. 4 are formed in the light-emitting device of this embodiment mode as illustrated in FIG. 5. It is to be noted that the portions that are common with those in FIG. 4 are denoted by the same reference numerals in FIG. 5.

The switching transistor 111 includes the island-like semiconductor film 201 and part of the gate line 122 as a gate electrode. The first driving transistor 112 includes the island-like semiconductor film 203 and the gate electrode 213. The second driving transistor 114 includes the island-like semiconductor film 203 and the gate electrode 212. The storage capacitor 113 includes the island-like semiconductor film 202 and the electrode 214.

The resistor 115 is formed using a region under the electrode 215 in the island-like semiconductor film 203.

As described above, FIG. 6 is a cross-sectional view taken along line A-A of FIG. 4. A method for manufacturing the light-emitting device of the present invention will be described below.

A base film 242 is formed over a substrate 241, and further, a semiconductor film is formed thereover. For the substrate 241, glass, plastic, paper, or the like can be used. A silicon oxide film, a silicon oxide film containing nitrogen, or a silicon nitride film containing oxygen can be used as the base film 242.

A crystalline semiconductor film such as silicon (Si), silicon germanium (SiGe), gallium arsenide (GaAs), or zinc oxide (ZnO), or an amorphous semiconductor film can be used as the semiconductor film. Alternatively, an organic semiconductor film formed using pentacene, oligothiophene, or the like can be used.

In this embodiment mode, an LDD structure (having a low concentration impurity region) is employed in each of the switching transistor 111, the first driving transistor 112, and the second driving transistor 114. The switching transistor 111 is an n-channel transistor.

First, a glass substrate and a silicon oxide film containing nitrogen are used as the substrate 241 and the base film 242, respectively. A 50 nm thick amorphous silicon film is formed over the base film 242 using a CVD apparatus. Then a material to promote crystallization of silicon such as an aqueous solution containing nickel (Ni) is added onto the surface of the amorphous silicon film. The amorphous silicon film is subjected to such heat treatment, for example, that it is heated in an electric furnace or the like at 600° C. for 4 hours to be crystallized.

It is to be noted that a semiconductor film formed over the base film 242 is not limited to the above materials; a crystalline semiconductor film obtained by forming an amorphous semiconductor film and crystallization thereof by laser irradiation may be alternatively used. In addition, a film obtained by forming a microcrystalline semiconductor film and crystallization thereof may be used instead of crystallizing an amorphous semiconductor film.

Next, an impurity element imparting one conductivity type to a semiconductor film such as an impurity element imparting p-type conductivity is introduced; specifically, boron (B) is given as the impurity element. For example, boron (B) is introduced into the semiconductor film at a concentration of 10¹⁶ atoms/cm³ using a doping apparatus.

Next, the semiconductor film is etched using, for example, a dry etching apparatus; thus the island-like semiconductor film 201 and the island-like semiconductor film 203 are formed (see FIG. 7A).

Next, a first electrode 231 of an inorganic EL element 205 is formed (see FIG. 7B). In this embodiment mode, the first electrode 231 is formed as follows: a 150 nm thick indium tin oxide (ITO) film is formed using a sputtering apparatus or the like and it is etched using a wet etching apparatus, a dry etching apparatus, or the like.

It is to be noted that, for the first electrode 231, a conductive film having a light-transmitting property may be used. As well as ITO, indium tin oxide containing silicon (also referred to as “ITSO” in this specification), indium zinc oxide (also referred to as “IZO” in this specification), and indium tin oxide containing tungsten oxide and silicon oxide (also referred to as “IWZO” in this specification) can be used.

Next, a gate insulating film 243 to cover the island-like semiconductor film 201 and the island-like semiconductor film 203 is formed (see FIG. 7C). In this embodiment mode, for example, a 100 nm thick silicon oxide film containing nitrogen is formed using a CVD apparatus, a sputtering apparatus, or the like. Then, the silicon oxide film is etched using a wet etching apparatus, a dry etching apparatus, or the like, so that the first electrode 231 is exposed.

As the gate insulating film 243, a single-layer film of a silicon oxide film, a silicon nitride film, a silicon nitride film containing oxygen, an aluminum nitride oxide film, a barium titanate film, or the like or a multilayer film formed using a combination of these films can be used as well as a silicon oxide film containing nitrogen.

Next, over the gate insulating film 243, a conductive film, for example, molybdenum (Mo) film is formed to a thickness of 150 nm using a sputtering apparatus. Then, the molybdenum film is etched using a wet etching apparatus, a dry etching apparatus, or the like to form a gate electrode 211, a gate electrode 212, an electrode 215, and an electrode 216 (see FIG. 7D). The electrode 216 partially overlaps with and is electrically connected to the first electrode 231.

In this embodiment mode, it is to be noted that the gate electrode 211 corresponds to part of the gate line 122. Otherwise, the gate electrode 211 and the gate line 122 may be formed separately and then electrically connected to each other.

It is to be noted that a single-layer film formed using tungsten (W), aluminum (Al), titanium (Ti), tantalum (Ta), or the like or a multilayer film formed using a combination thereof can be used as the conductive film as well as a molybdenum film. Alternatively, the conductive film can be formed of metal nano paste made of silver (Ag), gold (Au), or the like using an apparatus such as an ink jet apparatus.

Thereafter, in order to form the second driving transistor 114 which is an n-channel TFT and the first driving transistor 112 which is a p-channel TFI, an impurity element imparting n-type conductivity and an impurity element imparting p-type conductivity are introduced. It is to be noted that a low concentration impurity region (also referred to as an LDD region) is not illustrated in order to avoid making the drawings complicated.

First, in order to form a low concentration impurity region (also referred to as an LDD region) of the second driving transistor 114 which is an n-channel TFT, a mask is formed using a resist or the like in a region to be the first electrode 231 and the first driving transistor 112 which is a p-channel TFI, and phosphorus (P), for example, is introduced using a doping apparatus at a concentration of 10¹⁷ atoms/cm³.

Further, in order to form a source region and a drain region of the second driving transistor 114 which is an n-channel TFT, a mask is formed using a resist or the like in a region to be the low concentration impurity region, and phosphorus (P) is introduced at a concentration of 10²⁰ atoms/cm³.

In a similar manner as described above, in order to from a low concentration impurity region (also referred to as an LDD region) of the first driving transistor 112 which is a p-channel TFT, a mask is formed using a resist or the like in a region to be the first electrode 231 and the second driving transistor 114 which is an n-channel TFi, and boron (B) is introduced at a concentration of 10¹⁷ atoms/cm³.

Further, in order to form a source region and a drain region of the first driving transistor 112 which is a p-channel TFT, a mask is formed using a resist or the like in the region to be the low concentration impurity region, and boron (B) is introduced at a concentration of 10²⁰ atoms/cm³.

It is to be noted that an impurity element imparting n-type conductivity, an impurity element imparting p-type conductivity, and the dose amount may be changed if necessary and not limited to the above description.

At this time, the region under the electrode 215 in the island-like semiconductor film 203 is not doped with the impurity elements imparting n-type conductivity or p-type conductivity. It is to be noted that an impurity element imparting one conductivity type has been introduced into the semiconductor film to be the island-like semiconductor film 203. Thus, the region under the electrode 215 in the island-like semiconductor film 203 can be used for the resistor 115.

The switching transistor 111 is an n-channel transistor. Similarly to the second driving transistor 114 which is an n-channel transistor, a channel formation region 251, a region 252a to be one of a source region and a drain region, and a region 252b to be the other of the source region and the drain region of the switching transistor 111 are formed. Low concentration impurity regions may be formed between the channel formation region 251 and the region 252a as well as between the channel formation region 251 and the region 252b.

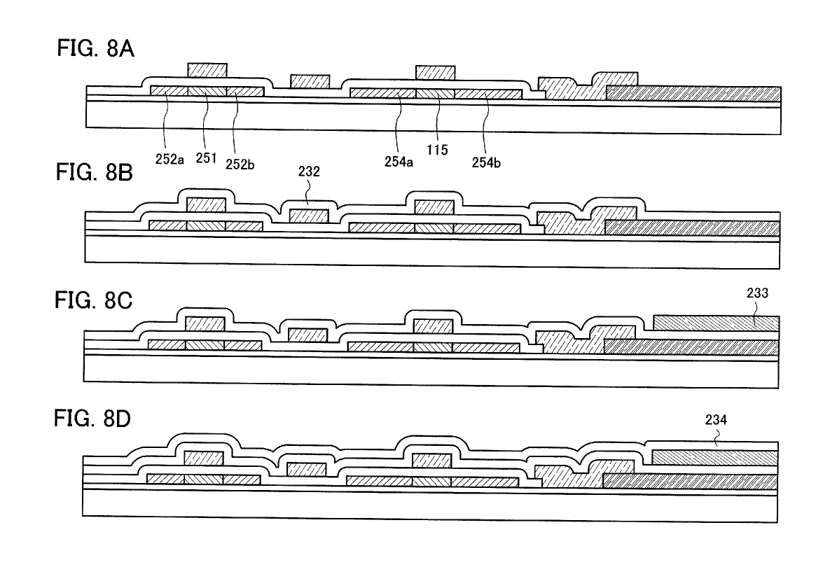

An impurity region 254a and an impurity region 254b are formed adjacent to the resistor 115 in a similar manner (see FIG. 8A). Low concentration impurity regions may be formed between the resistor 115 and the impurity region 254a as well as between the resistor 115 and the impurity region 254b.

Next, an insulating film 232 is formed so that the gate insulating film 243, the gate electrode 211, the gate electrode 212, the electrode 215, the electrode 216, and the first electrode 231 are covered therewith. In this embodiment mode, as the insulating film 232, a 200 nm thick silicon nitride film is formed using a CVD apparatus, a sputtering apparatus, or the like. The insulating film 232 functions not only as an insulating film to be one of the films that interpose a light-emitting layer 233 but also a passivation film of the switching transistor 111, the first driving transistor 112, and the second driving transistor 114.

The light-emitting layer 233 is formed over the first electrode 231 with the insulating film 232 interposed therebetween (see FIG. 8C). In this embodiment mode, manganese (Mn) and zinc sulfide are used as an impurity element and a base material, respectively. For example, as the light-emitting layer 233, a 500 nm thick film is formed using zinc sulfide containing manganese (Mn) of 0.5 wt % by sputtering, evaporation, or the like.

At this time, a different color emission is obtained by changing the impurity element contained in zinc sulfide; therefore, color display is possible.

In addition, the following semiconductors can be used for the light-emitting layer 233 as well as the above materials: zinc oxide, a mixed crystal of zinc oxide and magnesium oxide, zinc telluride, cadmium sulfide, and the like.

Next, an insulating film 234 is formed over the light-emitting layer 233 and the insulating film 232 (see FIG. 8D). In this embodiment mode, as the insulating film 234, a 200 nm thick silicon nitride film is formed using a CVD apparatus, a sputtering apparatus, or the like.

As described above, the light-emitting layer 233 has a structure in which it is interposed between the insulating film 232 and the insulating film 234.

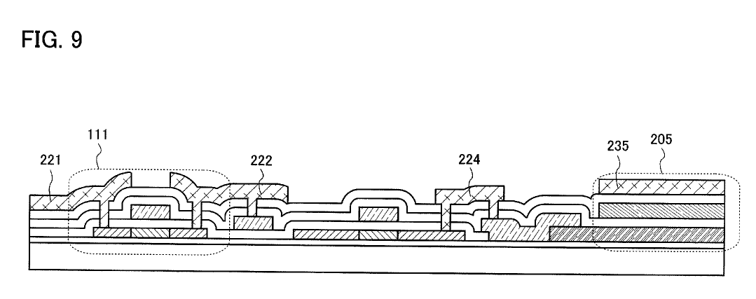

Next, the gate insulating film 243, the insulating film 232, and the insulating film 234 are partially etched to form contact holes, and a conductive film is formed over the insulating film 234. In this embodiment mode, as this conductive film, a 300 nm thick Al—Ti alloy film made of an alloy of aluminum (Al) and titanium (Ti) is formed using a sputtering apparatus. The Al—Ti alloy film is etched using a wet etching apparatus, a dry etching apparatus, or the like to form an electrode 221 which is one of a source electrode and a drain electrode, the electrode 222 which is the other of the source electrode and the drain electrode, the electrode 224, and a second electrode 235 of the inorganic EL element 205 (see FIG. 9).

In this embodiment mode, it is to be noted that the electrode 221 corresponds to part of the source line 121. Otherwise, the electrode 221 and the source line 121 may be formed separately and electrically connected to each other.

Instead of an Al—Ti alloy film, aluminum (Al), titanium (Ti), molybdenum (Mo), silver (Ag), platinum (Pt), tungsten (W), indium tin oxide (ITO), or the like can be used for the conductive film. In addition, a single-layer or a multilayer film formed using a combination of the above materials can be used for the.

The electrode 221 is electrically connected to the region 252a in the switching transistor 111. The electrode 222 is electrically connected to the region 252b in the switching transistor 111 and the gate electrode 212.

The electrode 224 is electrically connected to the impurity region 254b and the electrode 216.

The inorganic EL element 205 includes the first electrode 231, the insulating film 232, the light-emitting layer 233, the insulating film 234, and the second electrode 235, and is a light-emitting element having a capacitive property.

It is to be noted that, the power supply line 223, which is not illustrated in FIG. 9, is formed using a similar material through a similar process to the electrode 221, the electrode 222, the electrode 224, and the second electrode 235 (see FIG. 4).

Next, the interlayer insulating film 244 is formed so that the electrode 221, the electrode 222, the electrode 224, the second electrode 235, and the insulating film 234 are covered therewith (see FIG. 6). In this embodiment mode, as the interlayer insulating film 244, a 1000 nm thick silicon oxide film containing nitrogen is formed using a CVD apparatus or the like.

Accordingly, a light-emitting device including the inorganic EL element 205 can be obtained.

In this embodiment mode, an example of a bottom emission-type light-emitting device manufactured using a top gate TFT for each of the switching transistor 111, the first driving transistor 112, and the second driving transistor 114; using a light transmitting conductive film for the first electrode 231; and using a conductive film containing a metal for the second electrode 235 is described. However, the present invention is not limited to this. A bottom gate type TFT can be used for each of a switching transistor and a driving transistor. The present invention can be applied to a top emission type light-emitting device with the reverse configuration in which a light transmitting conductive film and a conductive film containing a metal are used for a second electrode and a first electrode, respectively. In addition, a dual emission type light-emitting device can be manufactured with the use of a light transmitting conductive film for each of the first electrode and the second electrode.

### Embodiment Mode 3

This embodiment mode will describe electronic appliances including the light-emitting device described in Embodiment Mode 1 or 2 of the present invention. The electronic appliances of the present invention include the light-emitting elements described in Embodiment Modes 1 and 2. Therefore, a driving voltage applied to driving transistors can be lowered to reduce load on the driving transistors. Accordingly, a light-emitting device with high reliability and high definition can be obtained.

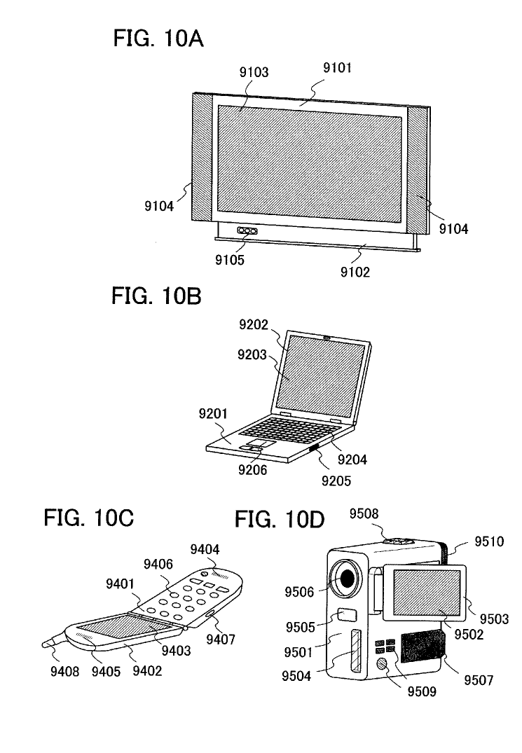

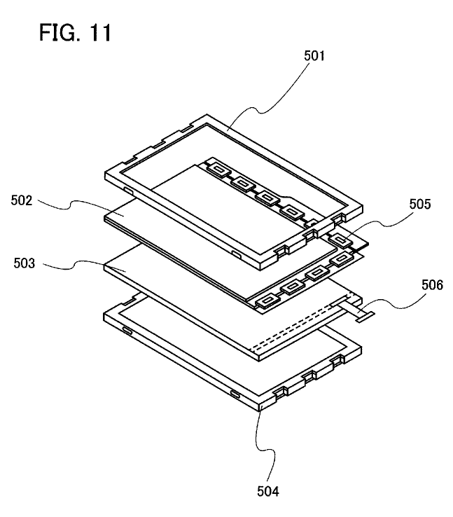

Examples of electronic appliances manufactured using the light-emitting device of the present invention include: cameras such as video cameras or digital cameras, goggle displays, navigation systems, audio reproducing devices (e.g., car audio components and audio components), computers, game machines, portable information terminals (e.g., mobile computers, mobile phones, portable game machines, and electronic books), image reproducing devices provided with recording media (specifically, the devices that can reproduce a recording medium such as a digital versatile disc (DVD) and is provided with a light-emitting device capable of displaying the reproduced images), and the like. Specific examples of these electronic appliances are illustrated in FIGS. 10A to 10D and FIG. 11.

FIG. 10A illustrates a television set in accordance with the present invention. The television set includes a chassis 9101, a supporting base 9102, a display portion 9103, speaker portions 9104, video input terminals 9105, and the like. In this television set, the display portion 9103 has a matrix arrangement of light-emitting elements similar to those described in Embodiment Modes 1 and 2.

In the light-emitting element formed in accordance with the present invention, a driving voltage applied to driving transistors can be lowered to reduce load on the driving transistors. Accordingly, a light-emitting device with high reliability and high definition can be obtained.

FIG. 10B illustrates a computer in accordance with the present invention. The computer includes a main body 9201, a chassis 9202, a display portion 9203, a keyboard 9204, an external connection port 9205, a pointing device 9206, and the like. In this computer, the display portion 9203 has a matrix arrangement of light-emitting elements similar to those described in Embodiment Modes 1 and 2.

In the light-emitting element formed in accordance with the present invention, a driving voltage applied to driving transistors can be lowered to reduce load of the driving transistors. Accordingly, a light-emitting device with high reliability and high definition can be obtained.

FIG. 10C illustrates a mobile phone in accordance with the present invention. The mobile phone includes a main body 9401, a chassis 9402, a display portion 9403, an audio input portion 9404, an audio output portion 9405, operation keys 9406, an external connection port 9407, an antenna 9408, and the like. In this mobile phone, the display portion 9403 has a matrix arrangement of light-emitting elements similar to those described in Embodiment Modes 1 and 2.

In the light-emitting element formed in accordance with the present invention, a driving voltage applied to driving transistors can be lowered to reduce load of the driving transistors. Accordingly, a light-emitting device with high reliability and high definition can be obtained.

FIG. 10D illustrates a camera in accordance with the present invention. The camera includes a main body 9501, a display portion 9502, a chassis 9503, an external connection port 9504, a remote controller receiving portion 9505, a image receiving portion 9506, a battery 9507, an audio input portion 9508, operation keys 9509, an eyepiece portion 9510, and the like. In this camera, the display portion 9502 has a matrix arrangement of light-emitting elements similar to those described in Embodiment Modes 1 and 2.

As described above, the applicable range of the light-emitting device of the present invention is so wide that the light-emitting device can be applied to electronic appliances in various fields. By using the light-emitting device of the present invention, an electronic appliance having a light-emitting device with high reliability, high definition and low production cost can be provided.

Further, because the light-emitting device of the present invention has light-emitting elements with high luminous efficiency, it can also be used as a lighting device. An example of using the light-emitting elements of the present invention as a lighting device will be described using FIG. 11.

FIG. 11 illustrates an example of a liquid crystal display device using the light-emitting device of the present invention as a backlight. The liquid crystal display device illustrated in FIG. 11 includes a chassis 501, a liquid crystal layer 502, a backlight 503, and a chassis 504, and the liquid crystal layer 502 is connected to a driver IC 505. The light-emitting device of the present invention is used as the backlight 503, and current is supplied through a terminal 506.

By using the light-emitting device of the present invention as a backlight of a liquid crystal display device, a backlight with high reliability, high definition and low production cost can be obtained. Further, the light-emitting device of the present invention is a lighting device with plane emission and can have a large area. Therefore, the backlight can have a large area, and a liquid crystal display device having a large area can be obtained. Furthermore, the light-emitting device of the present invention has a thin shape and has low power consumption; therefore, a thin shape and low power consumption of a display device can also be achieved.

### Embodiment 1

In this embodiment, a range of the resistance value R of the resistor 115 is calculated using formula 1 to 11 described in Embodiment Mode 1 under the following condition.

The parameter values will be described below.

V_{g}=6 V

Vₜₕₙ=1 V

V=200 V

L/W=10/10 μm

Cₒₓ=3.63×10⁻⁸ F/cm² (corresponding to a 100 nm thick silicon oxide film containing nitrogen which has a relative dielectric constant of 4.1)

μ=100 cm²/Vs (corresponding to a polycrystalline silicon film)

From the above description, the calculation result is the resistance value R of the resistor 115>2.2×10⁶ Ω.

Generally, for a thin film transistor including a polycrystalline silicon film as an active layer, 10¹⁵ to 10¹⁶ atoms/cm³ of an acceptor impurity is introduced into a region to be a channel formation region (a region under a gate electrode) in order to control a threshold.

This is converted into a resistivity of 1 to 10 Ωcm. The film resistance is given as ρ(l/(w·x)). It is to be noted that ρ is the film resistivity, and l, w, and x are the length, width, film thickness of the film in a region of the resistor 115, respectively.

In the case where the resistor 115 is formed using the polycrystalline silicon film in which the acceptor impurity is introduced, the calculation result is R=10⁶ Ω with l=w (that is, the resistor 115 becomes a square region), x=50×10⁻⁷ cm, and ρ=5 Ωcm for simplification.

Thus, the resistor 115 which enables linear operation of driving transistors can be formed by adjustment of a ratio of l and w.

Next, the relaxation time which is taken for the electric charges to be stored in the EL element under the above condition is estimated where R=10⁷ Ω.

The calculation result of the channel resistance of the second driving transistor 114 is r_{nc}=1/(3.63×10⁻⁸·100·5)=5.5×10⁴ Ω. The first electrode 231 is set as 100 μm×100 μm. Both the insulating films 232 and 234 interposing the light-emitting layer 233 are each set as a 200 nm thick silicon nitride film (a relative dielectric constant of 6).

A pixel capacitance Cₚᵢₓ is calculated as Cₚᵢₓ=2.7×10⁻¹² F. Accordingly, the relaxation time is τ=(R+r_{nc})·Cₚᵢₓ=(10⁷+5.5×10⁴)×2.7×10⁻¹²=2.7×10⁻⁵ sec.

The relaxation time is converted into a frequency as follows: frequency f=1/τ=1/2.7×10⁻⁵ Hz=3.7×10⁴ Hz. Thus, it is found that a light-emitting device of the present invention sufficiently functions with 30 kHz or less frequency of an AC driving voltage.

As described above, the light-emitting device of the present invention has a configuration described below.

The light-emitting device includes, a switching transistor, a first driving transistor which is a p-channel transistor, a second driving transistor which is an n-channel transistor, an inorganic EL element, and a resistor. In this light-emitting device, one of a source region and a drain region of the switching transistor is electrically connected to gate electrodes of the first driving transistor and the second driving transistor; one of a source region and a drain region of the first driving transistor and one of a source region and a drain region of the second driving transistor are electrically connected to the resistor; and the resistor and the inorganic EL element are electrically connected to each other. The resistor is provided between both the first driving transistor and the second driving transistor and the inorganic EL element; therefore, a driving voltage can be divided to the resistor.

A resistor formed using a region in which an impurity element imparting one conductivity type is introduced in an island-like semiconductor film is applicable for the aforementioned resistor.

The first driving transistor and the second driving transistor each operate in the linear region.

For the light-emitting device, the resistance value R of the resistor satisfies R>{(V−(V_{g}−Vₜₕₙ)}/{β·(V_{g}−Vₜₕₙ)²} and β=(W/L)·(Cₒₓ·μ) where V is a power supply voltage applied from a power source connected to one of a source region and a drain region of the first driving transistor, V_{d} is an intermediate potential between the first driving transistor and the second driving transistor, V_{g} is a gate potential applied to gate electrodes of the first driving transistor and the second driving transistor, Vₜₕₙ is a threshold voltage of the second driving transistor, W is a channel width of the second driving transistor, L is a channel length of the second driving transistor, Cₒₓ is capacitance per a unit area of a gate insulating film of the second driving transistor, and μ is the mobility of the second driving transistors.

This application is based on Japanese Patent Application serial no. 2006-299712 filed in Japan Patent Office on Nov. 3, in 2006, the entire contents of which are hereby incorporated by reference.

What is claimed is:

1. A light-emitting device comprising:
a transistor;
a p-channel transistor wherein a gate electrode of the p-channel transistor is electrically connected to the transistor and one of a source region or a drain region of the p-channel transistor is electrically connected to a first wiring;
an n-channel transistor wherein a gate electrode of the n-channel transistor is electrically connected to the transistor and one of a source region or a drain region of the n-channel transistor is electrically connected to a second wiring;
a resistor; and
an inorganic EL element electrically connected to another one of the source or the drain region of the p-channel transistor and another one of the source and the drain region of the n-channel transistor through the resistor.

2. The light-emitting device according to claim 1, wherein the resistor is formed using a region in which an impurity element imparting one conductivity type is introduced in an island-like semiconductor film.

3. The light-emitting device according to claim 1, wherein the inorganic EL element has a capacitive property.

4. The light-emitting device according to claim 1, wherein the first driving transistor and the second driving transistor each operate in a linear region.

5. The light-emitting device according to claim 4, wherein a resistance value R of the resistor satisfies R>{(V−(V_{g}−Vₜₕₙ)}/{β·(V_{g}−Vₜₕₙ)²} and β=(W/L)·(Cₒₓ·μ),
where V is a power supply voltage applied from a power source through the first wiring;
V_{d} is an intermediate potential between the p-channel transistor and the n-channel transistor;
V_{g} is a gate potential applied to the gate electrode of the p-channel transistor and a gate electrode of the n-channel transistor;
Vₜₕₙ is a threshold voltage of the n-channel transistor;
W is a channel width of the n-channel transistor;
L is a channel length of the n-channel transistor;
Cₒₓ is capacitance per a unit area of a gate insulating film of the n-channel transistor; and
μ is mobility of the n-channel transistor.

6. A light-emitting device comprising:
a first transistor;
a storage capacitor electrically connected to the first transistor;
a second transistor wherein a gate electrode of the second transistor is electrically connected to the first transistor and the storage capacitor and one of a source region and a drain region of the second transistor is electrically connected to a power source line;
an EL element electrically connected to the second transistor through a conductive layer,
wherein the conductive layer is in contact with at least an edge portion of a pixel electrode of the EL element, and
wherein the conductive layer overlaps the power supply line.

7. The light-emitting device according to claim 6, further comprising a resistor between the second transistor and the EL element.

8. The light-emitting device according to claim 7, wherein the resistor is formed using a region in which an impurity element imparting one conductivity type is introduced in an island-like semiconductor film.

9. The light-emitting device according to claim 6, wherein the EL element is an inorganic EL element.

10. The light-emitting device according to claim 6, wherein the EL element has a capacitive property.

11. The light-emitting device according to claim 6, wherein the power supply line overlaps the pixel electrode.

12. A light emitting device comprising:
a pixel electrode formed over a substrate;
a semiconductor film formed over the substrate;
a first insulating film formed over the semiconductor film;
a first conductive film formed over a part of the first insulating film and a part of the pixel electrode;
a second conductive film formed over the semiconductor film with the first insulating film interposed therebetween;
a second insulating film formed over the pixel electrode, the first conductive film and the second conductive film;
a first opening formed in the first insulating film and the second insulating film over the semiconductor film;
a second opening formed in the second insulating film over the first conductive film; and
a third conductive film formed over the second insulating film,
wherein the semiconductor film is electrically connected to the first conductive film through the first opening and the second opening by the third conductive film.

13. The light-emitting device according to claim 12, further comprising a light-emitting layer formed over the pixel electrode with the second insulating film interposed therebetween.

14. The light-emitting device according to claim 13, wherein the light-emitting layer comprises an inorganic compound.

15. The light-emitting device according to claim 12, wherein a region of the semiconductor film to which the third conductive film is connected comprises an impurity element imparting one conductivity type.
